(19) United States
(12) Patent Application Publication
(10) Pub. No.: US 2010/0154706 A1
(43) Pub. Date: Jun. 24, 2010

(54) LIQUID APPLYING APPARATUS

(75) Inventor: Mitsuru Kondo, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/627,928

(22) Filed: Nov. 30, 2009

(30) Foreign Application Priority Data
Dec. 19, 2008 (JP) 2008-323734

(51) Int. Cl. B05C 1/08

(52) U.S. Cl. 118/258

(57) ABSTRACT

A voltage value detected at the time of filling the liquid changes in accordance with viscosity. The voltage value is used as an indicator of the viscosity of the liquid at the time of a returning operation. Specifically, when the voltage value acquired at the filling time is low, the viscosity is determined as relatively high at the time of the returning operation, and a returning threshold value Th1 is set to a relatively high value. In concrete, the filling voltage is updated each time a filling operation is performed, and as the value of the filling voltage which is referred to at the time of the returning operation, the value which is acquired in the immediately preceding filling operation is used. Thereby, even when the liquid has relatively high viscosity, completion of the returning operation can be detected without increasing the time required before completion of the returning operation.

### BACKGROUND OF THE INVENTION

1. Field of the Invention

The present invention relates to a liquid applying apparatus, and specifically relates to a structure for detecting the amount of a liquid used in the liquid applying apparatus.

2. Description of the Related Art

As a method for detecting the remaining amount of ink or the presence/absence of ink in an inkjet print apparatus, a method is widely known, in which a voltage value at the time of passing a current through the ink is measured by using a pair of electrodes. In such a method, the electric conductivity of the ink easily changes depending on the shapes of the electrodes, the contact state of the electrodes with a liquid, the structure and viscosity of the liquid, a temperature, or the like, and therefore, a technique in which effects of these factors can be suppressed to detect the remaining amount or the like with high precision has been proposed.

Japanese Patent Laid-Open No. H03-270942 (1991) cites the problem that the viscosity of a liquid changes depending on an operation environment temperature and thereby, the flowability of the liquid changes, and for the solution to the problem, a method for changing threshold values used for determining the running-out state of an ink in accordance with the operation environment temperature.

For example, in the liquid applying apparatus as disclosed in Japanese Patent Laid-Open No. 2005-254809, a liquid is filled into a liquid holding portion in the liquid applying mechanism and is circulated therein at the time of using the liquid applying apparatus, and at the time of not using the apparatus, the liquid is drained from the liquid holding portion so that the liquid is returned to the tank. As a structure for detecting the state of filling and returning of the liquid, a liquid sensor is provided in the vicinity of the liquid holding portion. When a pair of electrodes in contact with the liquid in a tube is used as the liquid sensor, there arises the problem that quick detection is difficult especially in the returning operation depending on the state of the viscosity or the like of the liquid according to a change of the environmental conditions. As a result of this, when the operations of filling and returning of the liquid are performed in a continued flow of a printing operation, the print operation may become slow as a whole.

When returning the liquid, a voltage change through time, which is detected between a pair of electrodes, causes a completion of returning the liquid to be detected in, for example, about 20 and several seconds in the case of ink having the viscosity of a normal environment. More specifically, the liquid amount becomes small by the returning of liquid, and thus it takes 20 and several seconds before the detected voltage has a predetermined threshold value or lower. In contrast to this case, when the liquid has a viscosity higher than that of the above described normal environment due to an environmental change, it may take, for example, 60 seconds or more before the detected voltage has a threshold value or lower though actual returning of the liquid is finished at the point of time of a lapse of 20 seconds to 30 seconds. This is because the liquid has high viscosity and thus a voltage higher than the voltage value corresponding to the actual liquid amount occurs between the electrodes due to a bridge of the liquid between the electrodes, inclusion of air bubbles in the liquid and the like. As the cause of the liquid having a high viscosity, decreasing of the ambient temperature, reduction in density due to evaporation, inclusion of microscopic substances such as paper dust and the like are conceivable. As the method for preventing the bridge between the electrodes, increasing the distance between the electrodes is conceivable. However, when an installation place is small like the inside of a tube, if electrodes are disposed to be greatly apart from each other, the resistance value of a liquid becomes large. Therefore, the dynamic range of the conduction state decreases, detection precision becomes low, and the S/N ratio becomes worse. Further, it is conceivable to perform control depending on the ambient temperature by mounting a temperature sensor. However the factor of change in viscosity of a liquid is not only a temperature, and therefore, this coping arrangement may not be sufficient.

To deal with the problem of such a viscosity change, the detecting method disclosed in the aforementioned Japanese Patent Laid-Open No. H03-270942 (1991) provides a thermistor, which operates in response to the change of ambient temperature, in the detecting circuit to change the detection threshold value in accordance with the viscosity change due to an environmental change. Thereby, when the viscosity of a liquid is high, the threshold value is changed so that the detected voltage can be allowed to be equal to or lower than the threshold value at the same timing as the actual completion of returning.

However, the method described in Japanese Patent Laid-Open No. H03-270942 (1991) needs the additional component that is a thermistor and thus has the problem of complicating a structure for detecting a liquid amount correspondingly. Further, as in the case of using the above described temperature sensor, when the viscosity change of the liquid is caused by the factors other than the temperature change, the structure using the thermistor disclosed in Japanese Patent Laid-Open No. 2005-254809 also has the problem of being unable to deal with the viscosity change.

### SUMMARY OF THE INVENTION

An object of the present invention is to solve the above problems and is to provide a liquid applying apparatus which includes a simple liquid amount detecting structure in a mechanism which fills a liquid in a liquid holding portion and returns the liquid from the liquid holding portion.

In a first aspect of the present invention, there is provided a liquid applying apparatus comprising: an applying roller configured to apply a liquid to a medium; a liquid holding portion configured to contact with said applying roller for holding the liquid to be applied by said applying roller; a tank configured to store the liquid; a path configured to make a communication between said liquid holding portion and said storage unit; a pump configured to cause a flow of the liquid in a flow passage including said liquid holding portion, said storage unit and said path; a pair of electrodes provided in at least one of said liquid holding portion and said path; an output unit configured to output information corresponding to a conduction state between said pair of electrodes; a memory configured to store the information outputted by said output unit at time of a filling operation which uses said pump to fill said liquid holding portion with the liquid supplied from said storage unit through said path; a setting unit configured to set a threshold value used for determining a completion of a returning operation, which uses said pump to return the liquid in said liquid holding portion to said storage unit through said path, based on the information stored in said memory; and a determining unit configured to determine whether or not the returning operation is completed, based on the threshold value set by said setting unit and the information outputted by said output unit at time of the returning operation.

According to the above structure, the threshold value for determining completion of liquid returning can be determined based on the information which is stored in the memory and corresponds to the conduction state between a pair of electrodes at liquid filling, which is stored in the memory. More specifically, the information corresponding to the above described conduction state between the electrodes at the time of the filling corresponds to information on a value based on the viscosity of the liquid at the time of filling. In liquid returning which is performed after the above described filling, the threshold value for determining completion of liquid returning is determined based on the information on the value based on the viscosity of the liquid at the above described time of filling, and therefore, the determined threshold value can be made the value corresponding to the viscosity of the liquid at the time of returning.

As a result, a liquid amount detecting arrangement which performs detection of a liquid amount with high precision at the time of returning operation with a simple structure can be provided.

Further features of the present invention will become apparent from the following description of exemplary embodiments (with reference to the attached drawings).

### BRIEF DESCRIPTION OF THE DRAWINGS

FIG. 1 is a schematic view of a liquid applying apparatus which is applied to an embodiment of the present invention;

FIGS. 2A and 2B are detailed views of a liquid sensor which is applied to the embodiment of the present invention;

FIG. 3 is a functional block diagram showing a control system which is applied to the embodiment of the present invention;

FIG. 4 is a flowchart of a filling and returning sequence which is applied to the embodiment of the present invention;

FIG. 5 is a chart showing a change in a detection voltage with respect to an elapsed time of the liquid sensor in the embodiment of the present invention, and is a diagram showing a filling time using a liquid with normal viscosity;

FIG. 6 is a chart showing a change in a detection voltage with respect to an elapsed time of the liquid detecting sensor in the embodiment of the present invention, and is a diagram showing the filling time using a liquid with high viscosity;

FIG. 7 is a chart showing a change in the detection voltage with respect to an elapsed time of the liquid detecting sensor in the embodiment of the present invention, and is a diagram showing a returning time using a liquid with normal viscosity;

FIG. 8 is a chart showing a change in the detection voltage with respect to an elapsed time of the liquid detecting sensor in the embodiment of the present invention, and is a diagram showing a returning time using a liquid with high viscosity;

FIG. 9 is a longitudinal sectional side view showing a schematic construction of an inkjet print apparatus in the embodiment of the present invention;

FIG. 10 is a diagram showing a detection voltage Vh-returning threshold value Th1 table which is applied to a first embodiment of the present invention;

FIG. 11 is a chart showing the detection voltage Vh-returning threshold value Th1 table, which is applied to the first embodiment of the present invention, in a graphical form;

FIG. 12 is a chart of the calculation formula of the returning threshold value Th1, which is applied to a second embodiment of the present invention, in a graphical form;

FIG. 13 is a chart of the calculation formula of the returning threshold value Th1, which is applied to a third embodiment of the present invention, in a graphical form;

FIG. 14 is a perspective view showing an entire construction of an embodiment according to the liquid applying apparatus of the present invention;

FIG. 15 is a longitudinal sectional side view showing one example of arrangement of a applying roller, a counter roller, a liquid holding member and the like shown in FIG. 14;

FIG. 16 is a front view of the liquid holding member shown in FIGS. 14 and 15; and

FIG. 17 is a longitudinal sectional view showing the state in which a liquid is filled into a liquid holding space formed by the liquid holding member and the applying roller, and an applying medium is coated with the liquid by rotation of the applying roller, in the embodiment of the present invention.

### DESCRIPTION OF THE EMBODIMENTS

Hereinafter, embodiments of the present invention will be described in detail with reference to the drawings.

### First Embodiment

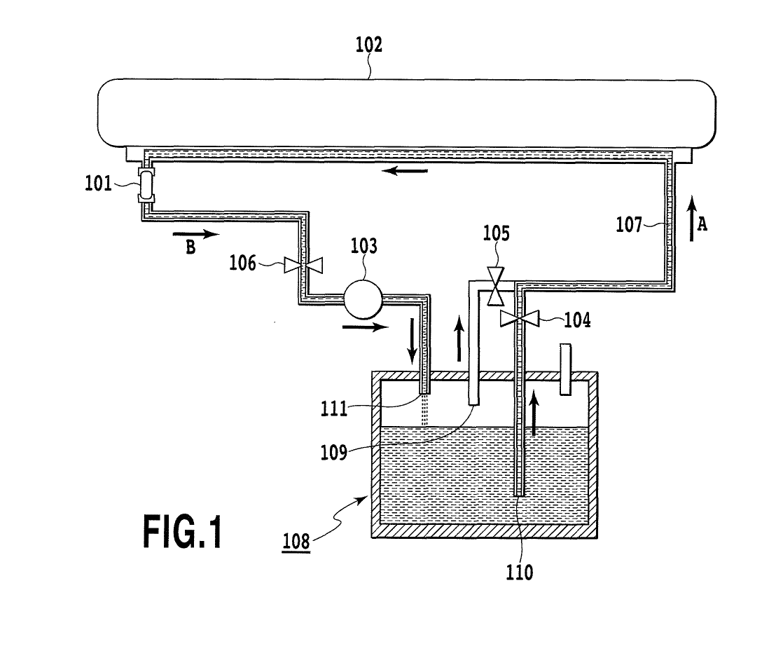

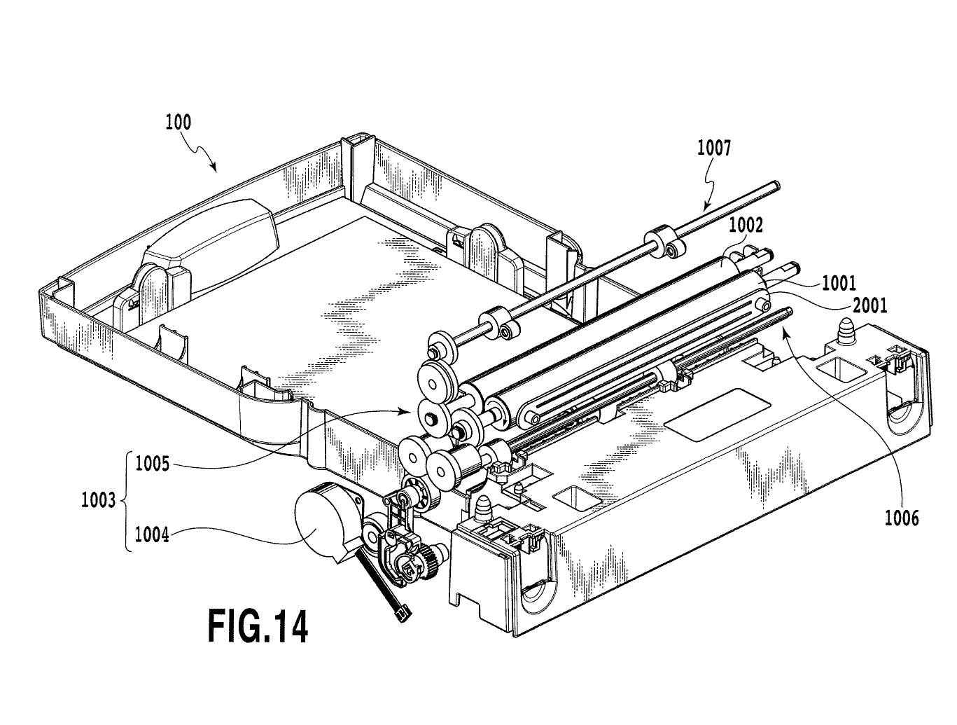

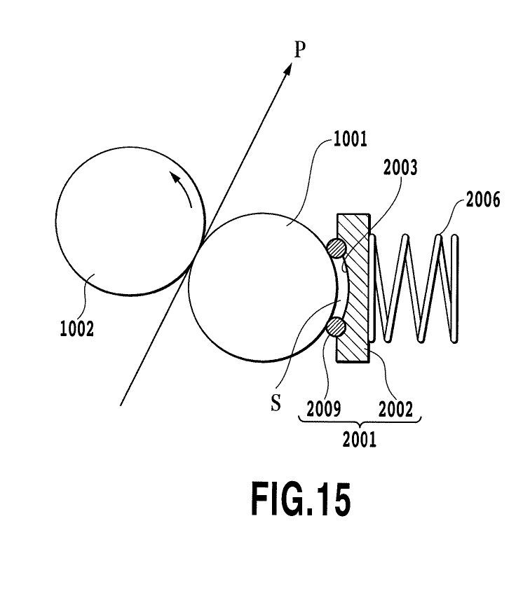

FIG. 1 is a schematic view showing a main part of a liquid applying apparatus according to a first embodiment of the present invention. In FIG. 1, a liquid retained in a tank 108 is supplied in a direction of the arrow A in the drawing through a tube 107 to fill a liquid holding portion of a liquid applying mechanism 102 with the liquid. Further, at a non-operating time of the liquid applying apparatus, the liquid is discharged in a direction of the arrow B in the drawing from the above described liquid holding portion and is returned to the tank 108. The operations of supply and filling, and discharge and returning of the liquid are performed by driving a pump 103. The liquid applying mechanism 102 includes the liquid holding portion and an applying roller as described later with reference to FIGS. 14 to 15, so that the liquid held in the liquid holding portion contacts with the applying roller, and thereby, the liquid is supplied onto the applying roller. The supplied liquid on the applying roller is applied on a medium.

When supplying the liquid to fill the liquid holding portion of the liquid applying mechanism 102 with the liquid, the pump 103 is driven, a valve 104 and a valve 106 are opened, and a valve 105 is closed. Thereby, the liquid is sucked out of the tank 108, and reaches the liquid holding portion of the liquid applying mechanism 102 through the tube. Further, by continuing the pump driving in the same state as the above described supply, the supplied liquid returns to the tank 108 in the direction of the arrow B through the liquid holding portion. In this manner, circulation of the liquid is performed.

When the liquid is to be returned, the pump 103 is driven, the valve 104 is closed, and the valves 105 and 106 are opened. Thereby, the air inside the tank 108 is sucked out, the air is fed to the tube 107 and the liquid applying mechanism 102, and thus the liquid in the tube 107 and the liquid holding portion of the liquid applying mechanism 102 is returned to the tank 108.

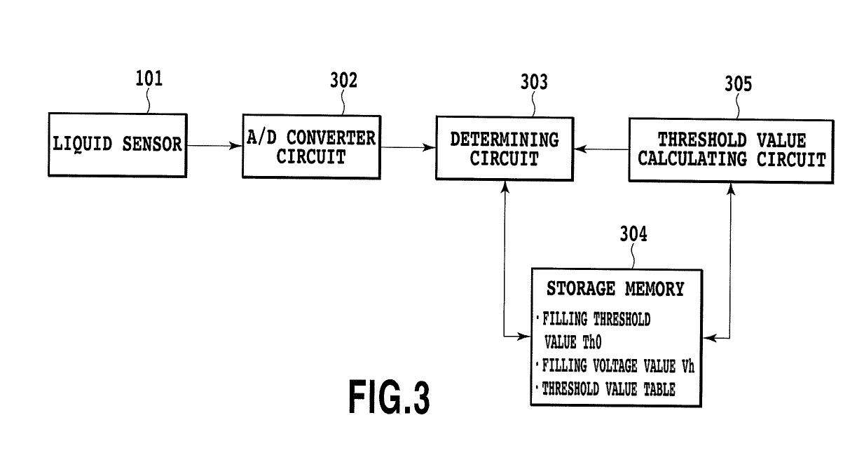

Here, the valve 106 is a check-valve which is closed at the non-operating time of the liquid applying apparatus. When a liquid applying operation is performed, it is desirable that the liquid holding portion of the liquid applying mechanism 102 is always in the state filled with a liquid. Determination of whether or not the liquid is filled into the liquid holding portion of the liquid applying mechanism 102 is performed by using a configuration including a liquid sensor 101, shown in FIG. 3. When it is confirmed that the liquid holding portion is filled with a liquid, a liquid applying operation is started. During the liquid applying operation, the liquid is circulated by continuing to drive the pump 103. When the liquid applying operation is completed, the liquid remaining in the tube 107 and the liquid applying mechanism 102 is returned to the tank 108. Determination of whether or not returning of the liquid is completed is also performed by using the configuration including the liquid sensor 101, which is shown in FIG. 3.

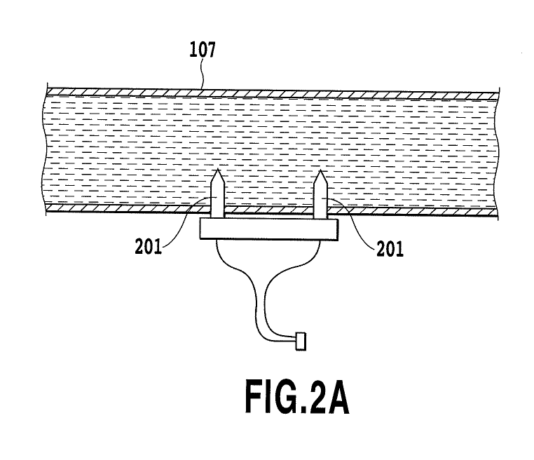

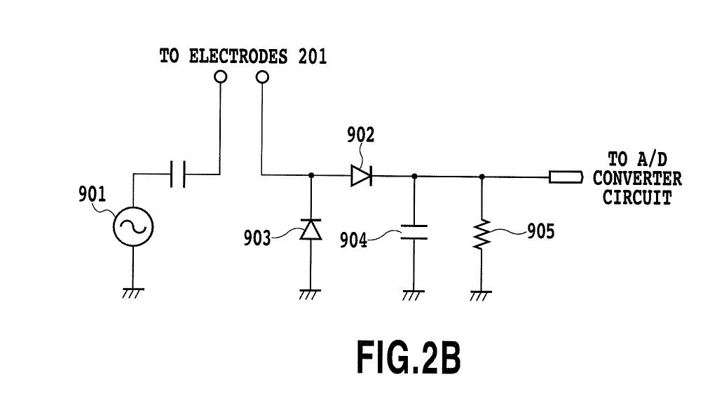

FIGS. 2A and 2B are views showing the details of the liquid sensor 101 shown in FIG. 1. As shown in FIG. 2A, the liquid sensor 101 has a pair of electrodes 201 provided inside the tube 107. FIG. 2B is a circuit diagram showing one example of a circuit for performing liquid amount detection using the electrodes 201. As shown in FIG. 2B, AC current from an AC power supply 901 is supplied to one of the electrodes. When a liquid is present between the electrodes, the electrodes are in the state equivalent to the state connected with a predetermined resistor, and thus the AC current is transmitted to the other electrode. The AC current which is transmitted through the liquid is smoothed by diodes 902 and 903 and a capacitor 904. The smoothed current flows into a resistor 905, and a potential difference corresponding to the presence of the liquid occurs to both ends of the resistor 905. On the other hand, when the liquid is not present between the electrodes, the electrodes are in an insulated state, and therefore, a potential difference does not occur between both the ends of the resistor 905. Accordingly, by measuring the potential difference between both the ends of the resistor 905, the amount and the presence or absence of the liquid between the electrodes can be determined. The liquid amount detecting circuit outputs the voltage value (voltage value corresponding to the conduction state between a pair of electrodes) corresponding to the potential difference which is measured as described above to an A/D converter circuit 302 shown in FIG. 3.

FIG. 3 is a functional block diagram showing a control system related to the liquid amount detection of the embodiment of the present invention. In FIG. 3, the liquid sensor 101 is constructed by including the electrodes and the liquid amount detecting circuit as described above. The A/D converter circuit 302 converts an analog voltage value outputted from the liquid sensor 101 into a digital voltage value, and outputs the converted digital voltage value to a determining circuit 303. The digital voltage value corresponds to the information relating to the voltage value based on the conduction state between the above described pair of electrodes. The determining circuit 303 performs determination on whether or not the operation of filling (supplying) the liquid into the liquid holding portion is normally performed, determination on whether or not the operation of returning (discharge) of the liquid from the liquid holding portion is completed, and the like by comparing the digital voltage value outputted from the A/D converter circuit 302 with a threshold value which is obtained as follows.

At the time of filling operation, the determining circuit 303 reads out a filling threshold value Th0 from a storage memory 304, and makes comparative determination of the filling threshold value Th0 and the voltage value obtained from the A/D converter circuit 302, and thereby, performs determination on whether or not the filling operation is normally performed. Further, the determining circuit receives a voltage value Vh in the filled state from the A/D converter circuit 302 after filling, and writes (stores) the voltage value Vh to the storage memory 304. Meanwhile, at the time of a returning operation, a threshold value calculating circuit 305 as threshold value setting means reads out the voltage value Vh of the filled state from the storage memory 304, calculates (sets) a returning threshold value Th1 by referring to the threshold table (correspondence table) stored in the storage memory 304, and transfers the returning threshold value Th1 to the determining circuit 303. The determining circuit 303 makes comparative determination of the received returning threshold value Th1 and the voltage value obtained from the A/D converter circuit 302 at the time of the returning operation, and thereby, determines whether or not the liquid returning (discharge) operation is completed.

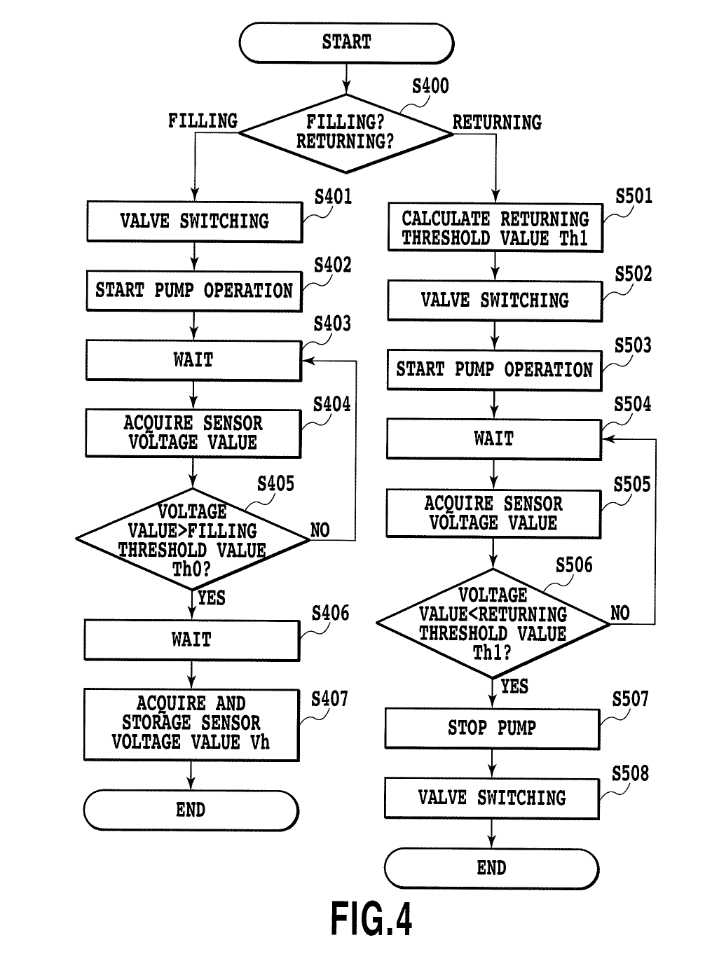

FIG. 4 is a flowchart showing a filling and returning process of a liquid according to the first embodiment of the present invention. First, in step S400, it is determined whether the filling operation or returning operation is performed.

In the case of a filling operation, first in step S401, valve switching is performed. More specifically, the valve 104 and the valve 106 shown in FIG. 1 are opened, and the valve 105 is closed. Next, a pump operation is started in step S402. Then, in step S403, the process waits until the liquid is sucked out of a liquid outlet port 110 in the tank 108 and moves in the tube. During the waiting time, the pump continues to be driven. Next, in step S409, the A/D converter circuit 302 acquires the voltage value at the present point of time from the liquid sensor 101, converts it into a digital value, and thereafter, outputs the digital value to the determining circuit 303. Thereby, the determining circuit 303 acquires the digital voltage value. Subsequently, in step S405, the determining circuit 303 determines whether or not the voltage value acquired in step S404 is larger than the filling threshold value Th0. In step S405, in a case that it is determined that the voltage value is larger than the filling threshold value Th0, it is determined that the filling operation of the liquid normally functions (liquid normally flows in the tube), and the process goes to step S906. On the other hand, when it is determined that the voltage value is equal to or smaller than the filling threshold value Th0 in step S405, the process returns to step S403. Here, the filling threshold value Th0 is defined as a predetermined value which is set in advance. When it is determined that the voltage value is equal to or smaller than the filling threshold value Th0 even if determination in step S405 is repeated by a predetermined number of times (for example, five times), it is determined that the flow of the liquid is not normal due to failure of the pump or the like, and the process shifts to error processing (not illustrated).

In step S406, the process waits for a predetermined time which is set in advance within which the liquid is sufficiently filled into the liquid holding portion of the liquid applying mechanism 102 and the tube. During the waiting time, the pump continues to be driven. Subsequently, in step S407, in the state in which the liquid is sufficiently filled, the A/D converter circuit 302 acquires the voltage value at this point of time from the liquid sensor 101 again, converts it into a digital value, and thereafter, outputs the digital value to the determining circuit 303. Thereby, the determining circuit 303 acquires the digital voltage value. The voltage value acquired by the determining circuit 303 here is set as Vh. The determining circuit 303 stores the voltage value Vh in the storage memory. This completes the filling operation.

Meanwhile, in the case of the returning operation, first, in step S501, the threshold value calculating circuit 305 as threshold setting means sets a returning threshold value Th1. Here, the returning threshold value Th1 is not a fixed value which is set in advance, but is set for each returning operation. The method for setting the returning threshold value Th1 will be described later. Next, in step S502, valve switching is performed. The valve 105 and the valve 106 shown in FIG. 1 are opened, and the valve 104 is closed. Subsequently, in step S503, the pump operation is started. Thereby, in step S504, the process waits until air is sucked out of the air outlet port 109 in the tank 108 and the air moves inside the tube. During the waiting time, the pump continues to be driven. Next, in step S505, the A/D converter circuit 302 acquires the voltage value at the present point of time from the liquid sensor 101, converts it into a digital value, and thereafter, outputs the digital voltage value to the determining circuit 303. Thereby, the determining circuit 303 acquires the digital voltage value. When the determining circuit 303 determines that the voltage value is smaller than the returning threshold value Th1 in step S506 of determining whether or not the voltage value acquired in step S505 is smaller than the returning threshold value Th1, the determining circuit 303 determines that returning of the liquid is completed to proceed to step S507. On the other hand, when it is determined that the voltage value is equal to or larger than the returning threshold value Th1 in step S506, the process returns to step S504. In step S507, the pump is stopped, and in step S508, all the valves are closed, and the returning operation is completed. When it is determined that the voltage value is equal to or larger than the returning threshold value Th1 even if determination in step S506 is repeated by the predetermined number of times (for example, five times), it is determined that the flow of the liquid is not normal due to failure or the like of the pump, and the process shifts to error processing (not illustrated).

The calculating method (setting method) of the aforementioned returning threshold value Th1 will be described. For calculation of the returning threshold value Th1, the digital voltage value Vh which is acquired in step S407 and is stored in the memory at the time of the filling operation (immediately preceding filling operation) which is performed prior to the returning operation is used. Hereinafter, this reason will be described.

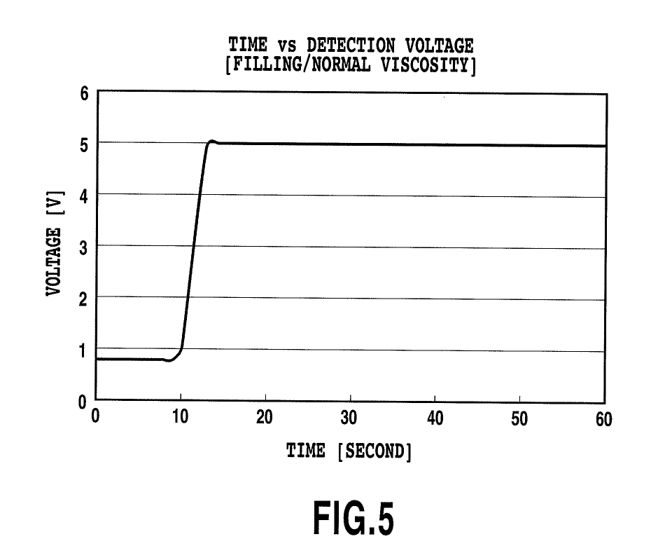

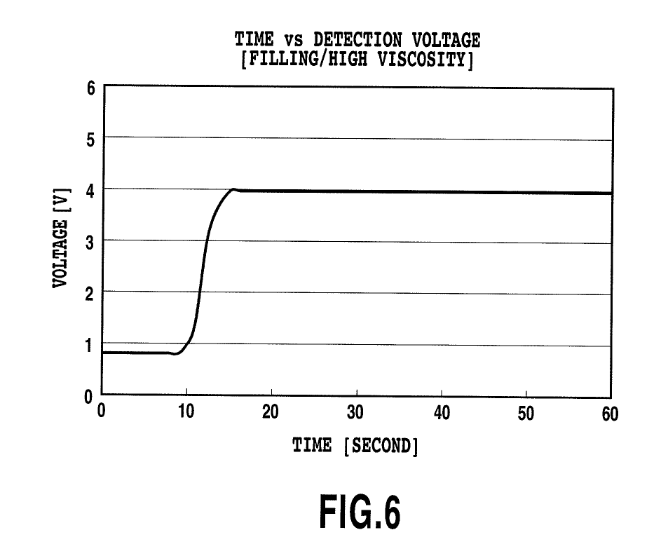

The voltage value measured by the liquid sensor 101 changes depending on the viscosity of the liquid. FIGS. 5 and 6 are diagrams showing the relationships of the voltage value measured by the liquid sensor 101 at the filling time, and the lapse of time, and respectively show changes in voltage values at the time with normal viscosity and the viscosity higher than the normal viscosity. The above described voltage value Vh is a voltage value obtained in the state in which filling of the liquid is completed in the above described step S407, and is shown as a constant value (voltage value after 20 seconds) in each of the drawings. Comparing the digital voltage values Vh in the case of normal viscosity shown in FIG. 5 and in the case of the viscosity higher than the normal viscosity shown in FIG. 6, the voltage value (3.9 V) in the case of the high viscosity is lower than the voltage value (5.0 V) in the case of the normal viscosity. That is, there is a relation that the higher the viscosity, the lower the voltage value Vh.

The inventor of the present application pays attention to the fact that the voltage value Vh detected at the filling time changes depending on viscosity, and uses the voltage value as the indicator of the viscosity of the liquid at the time of the returning operation. More specifically, the inventor considers that when the voltage value Vh acquired at the filling time is low, the viscosity is relatively high, and sets the returning threshold value Th1 at the time of the returning operation at a relatively high value.

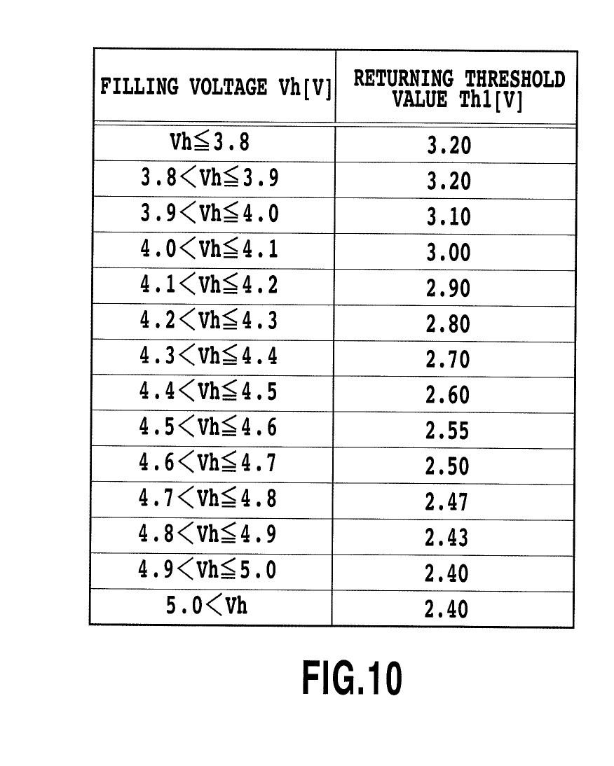

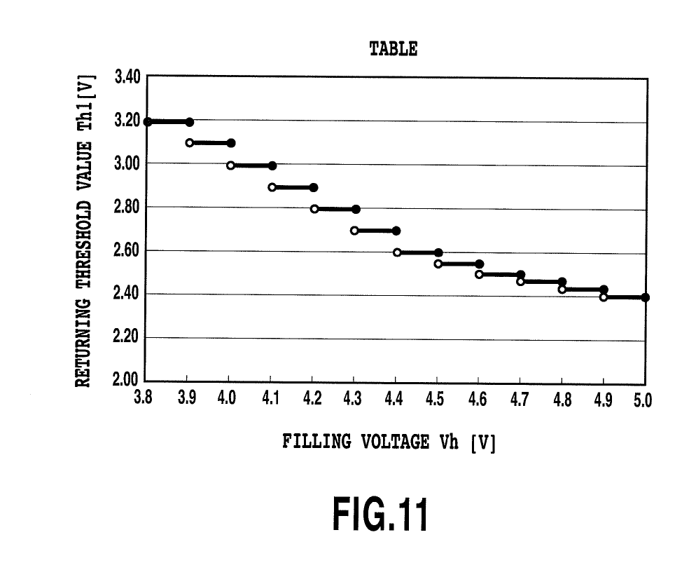

FIG. 10 is a view showing a table for obtaining the returning threshold value Th1 based on the voltage value Vh at the filling time. Further, FIG. 11 is a diagram expressing the table in a diagram. As shown in the drawings, the returning threshold value Th1 and the filling voltage Vh are in the relation of monotone decreasing. The returning operation is surely performed after the filling operation. The filling voltage Vh is updated each time a filling operation is performed, and as the value of the filling voltage Vh which is referred to at the time of the returning operation, the one that is acquired in the immediate preceding filling operation is always used.

By determining (setting) the returning threshold vale Th1 by the above method, even when the liquid has relatively high viscosity, the completion of the returning operation can be detected without the time required until the returning operation is completed not becoming longer than necessary.

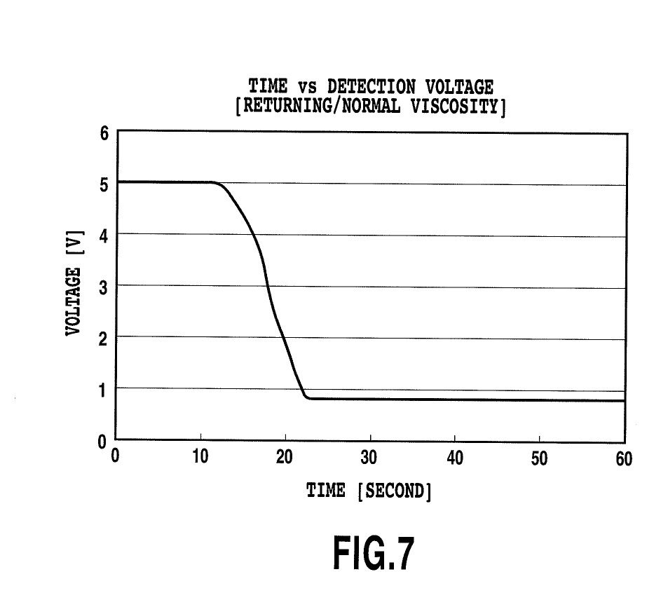

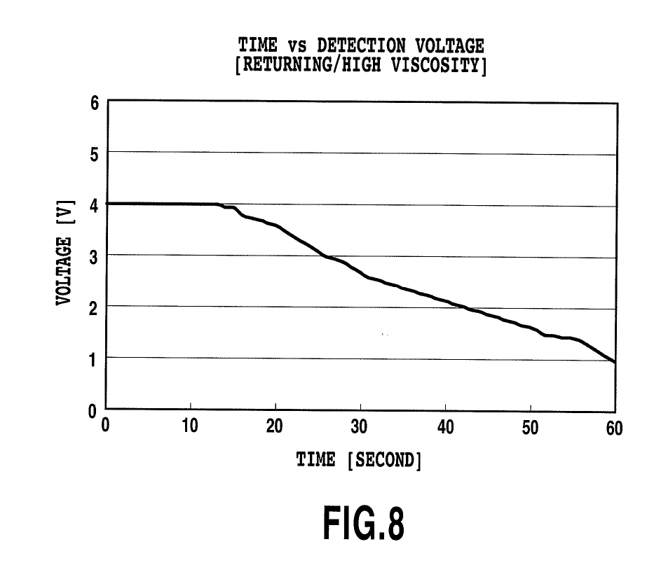

FIGS. 7 and 8 are diagrams each showing the change of the voltage value detected by the liquid sensor 101 at the time of the returning operation in accordance with the lapse of time. In the example shown in FIG. 5, the voltage value Vh at the filling time with normal viscosity is 5.0V, and therefore, the returning threshold value Th1 is 2.40 V from the table of FIG. 10. In this case, the time required until it is determined that returning is completed at the time of normal viscosity is about 20 seconds from FIG. 7. Similarly, the voltage value Vh at the filling time with high viscosity shown in FIG. 6 is 3.9 V, and therefore, the returning threshold value Th1 is 3.20 V from the table of FIG. 10. In this case, from the diagram shown in FIG. 8, the time required until it is determined that the returning is completed at the time of high viscosity is about 24 seconds. In contrast, if the determination is made with the same threshold value (2.40 V) as in the case of normal viscosity, about 37 seconds is required. In this way, according to the present embodiment, the completion can be detected at the timing of completion of an actual returning operation irrespective of the change of the viscosity of the liquid, and it can be prevented from being detected significantly later than the actual completion of returning.

As above, the threshold value for determining returning completion of a liquid can be decided based on the information which is stored in the memory and corresponds to the conduction state between a pair of electrodes at the time of liquid filling. More specifically, the information corresponding to the conduction state between the above described electrodes at the filling time becomes the information of the value corresponding to the viscosity of the liquid at the filling time. In the liquid returning which is performed after the above described filling time, the threshold value for determining returning completion of the liquid is decided based on the information of the value corresponding to the viscosity of the liquid at the above described filling time, and therefore, the determined threshold value can be set at the value corresponding to the viscosity of the liquid at the time of its returning. Thereby, liquid amount detection with high precision at the time of the returning operation can be performed with the simple construction.

### Second Embodiment

A second embodiment of the present invention differs in the calculating method of the threshold value Th1 from the aforementioned first embodiment, and the other structure and operation are the same as those of the first embodiment.

In the calculating method of the returning threshold value Th1 in the second embodiment, the returning threshold value Th1 is calculated by the following calculation formula by using the voltage value Vh acquired at the time of the filling operation which is performed immediately before the returning operation.

Th1=α×1/Vh

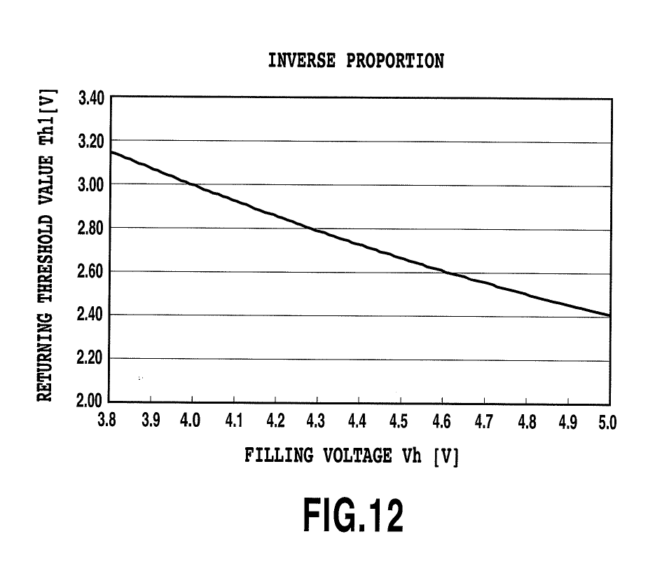

Here, α is a constant. The returning threshold value Th1 is calculated by performing the arithmetic operation of inverse proportion for Vh. FIG. 12 is a diagram showing the relationship of Th1 and Vh in the case of α=12.

### Third Embodiment

A third embodiment of the present invention likewise differs in the calculating method of the returning threshold Th1 from the first embodiment, and the other structure and operation are the same as those of the first embodiment.

In the calculating method of the returning threshold value Th1 of the third embodiment, the returning threshold value Th1 is calculated by the following calculation formula by using the voltage value Vh which is acquired at the time of the filling operation which is performed immediately before the returning operation.

Th1=α×1/Vh+β

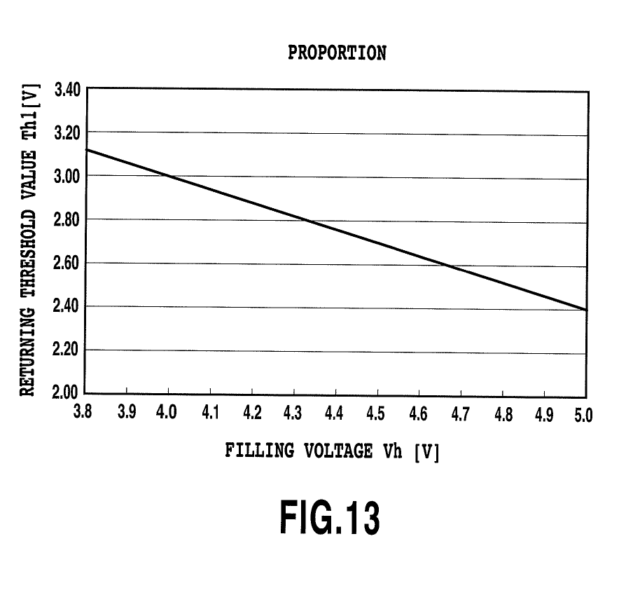

Here, α and β are constants. The returning threshold value Th1 is calculated by performing the arithmetic operation of proportion for Vh. FIG. 13 is a diagram showing the relationship of Th1 and Vh in the case of α=−0.6 and β=5.40.

### Other Embodiments

In the above described first to third embodiments, a pair of electrodes 201 are provided in the tube 107, and the amount and presence/absence of the liquid in the tube are determined in accordance with the conduction state of the electrodes, whereby it is indirectly determined whether or not the liquid returning from the liquid holding portion is completed. However, the method for determining completion of liquid returning is not limited to this. For example, a method may be adopted, in which a pair of electrodes are provided in the liquid holding member, the state of the liquid in the liquid holding portion is directly detected in accordance with the conduction state between the electrodes, and the returning completion is determined. Further, in order to enhance the precision of the determined result, in addition to providing a pair of electrodes in the tube, a pair of electrodes is also provided in the liquid holding member, and the above described determination may be performed by the two pairs of electrodes. Further, in the above described first to third embodiments, as the information corresponding to the conduction state between a pair of electrodes, the information relating to the voltage value corresponding to the conduction state between a pair of electrodes is used, but the information is not limited to this. The information relating to the current value, the resistance value and the like corresponding to the conduction state between a pair of electrodes may be used. In short, the information corresponding to the conduction state between a pair of electrodes relating to the amount and presence/absence of the liquid in the tube and in the liquid holding member can be used.

### (General Construction of the Apparatus)

FIG. 14 is a perspective view showing a general construction of a liquid applying apparatus 100 of each of the abovementioned embodiments. The liquid applying apparatus 100 generally constructed of the liquid applying mechanism 102 (FIG. 1) which coats a medium (hereinafter, also called an applying medium) which is a liquid applying subject with a liquid, and a liquid supply mechanism which supplies the liquid to the liquid applying mechanism. The liquid applying mechanism 102 has a cylindrical applying roller 1001 as a applying member and a liquid holding member 2001 which holds the liquid between the liquid holding member 2001 and the peripheral surface of the applying roller 1001. Further, the liquid applying mechanism 102 has a cylindrical counter roller (medium support member) 1002 disposed to be opposed to the applying roller 1001, a roller drive mechanism 1003 which drives the applying roller 1001, and the like. The roller drive mechanism 1003 is constructed by a roller drive motor 1009, a power transmitting mechanism 1005 having a gear train which transmits a drive force of the roller drive motor 1004 to the applying roller 1001, and the like.

Further, the liquid supply mechanism is constructed by including a later-described liquid flow path (not illustrated in FIG. 14) for supplying a liquid to the liquid holding member 2001, and the like. The applying roller 1001 and the counter roller 1002 which are described above with FIG. 1 and the like have both ends of them rotatably supported by shafts parallel with each other which are rotatably mounted to a frame not illustrated. Further, the liquid holding member 2001 extends over substantially the entire applying roller 1001 in the longitudinal direction, and is movably mounted to the above described frame via the mechanism which allows the liquid holding member 2001 to perform a contacting and separating operation to and from the peripheral surface of the applying roller 100.

The liquid applying apparatus further includes a applying medium supply mechanism 1006 which is constructed of a pickup roller and the like for transferring a applying medium to a nip portion of the applying roller 1001 and the counter roller 1002. Further, in the conveying path of the applying medium, a paper discharge mechanism 1007, which is constructed of a paper discharge roller and the like, and transfers the applying medium coated with a liquid to a paper discharge section (not illustrated), is provided at the rear stream side of the applying roller 1001 and the counter roller 1002. These paper supply mechanism and paper discharge mechanism are also operated by the drive force of the drive motor 1004 which is transmitted through the power transmitting mechanism 1005 in the same way as the applying roller and the like.

The above described liquid is a liquid which promotes cohesion of components (for example, a pigment) in a pigment ink containing a pigment as a coloring material, for example. One example of the components of the liquid is described as follows.

| | |
|---|---|
| Calcium nitrate/tetrahydrate | 10% |
| Glycerin | 42% |
| Surface active agent | 1% |
| Water | residue |

Further, the viscosity of the aforementioned liquid is 5 to 6 cP (centipoises) at 25° C. In application of the present invention, it is natural that the liquid is not limited to the above described one. For example, the liquid containing a component which suppresses curl of the applying medium can be used.

In the case of using water as a liquid, a sliding ability at the abutting portions of the applying roller and the liquid holding member of the present invention becomes favorable by containing the component which reduces surface tension in the aforementioned liquid. In the above described one example of the components of the liquid to be applied, glycerin and the surface active agent are the components which reduce the surface tension of water.

Next, the elements of each of the parts constituting the applying apparatus of which an outline is described above will be described in more detail. FIG. 15 is an explanatory longitudinal sectional side view showing one example of arrangement of the applying roller 1001, the counter roller 1002, the liquid holding member 2001 and the like. The counter roller 1002 is urged to the peripheral surface of the applying roller 1001 by urging means not illustrated. Thereby, by rotating the applying roller 1001 in the clockwise direction in FIG. 15, a applying medium P to be coated with a liquid can be sandwiched between both the rollers, and the applying medium P can be transferred in the arrow direction in FIG. 15.

Further, when the liquid holding member 2001 is urged to and abuts on the peripheral surface of the applying roller 1001 by the urging force of a spring member (pressing means) 2006, the liquid holding member 2001 forms a long liquid holding space S extending over the entire liquid applying region by the applying roller 1001. The liquid is supplied into the liquid holding space S through the liquid holding member 2001 from a liquid flow path which will be described later, and the liquid holding member 2001 is constructed as follows. Thereby, in the stopping state of the applying roller 1001, the liquid can be prevented from accidentally leaking outside from the liquid holding space S.

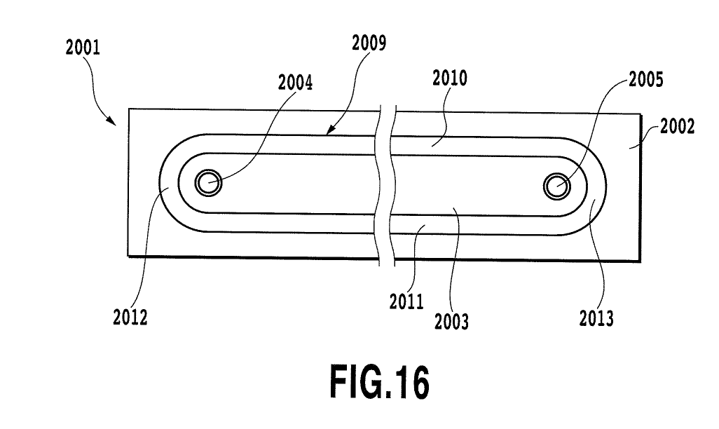

The configuration of the liquid holding member 2001 is shown in FIG. 16. As shown in FIG. 16, the liquid holding member 2001 is constructed of a space forming base member 2002, and an annular abutting member 2009 which is provided in a protruding form on one surface of the space forming base member 2002. A recessed portion 2003 with the sectional shape of its bottom portion forming an arc shape is formed in the space forming base member 2002 along the longitudinal direction in its central portion. The abutting member 2009 has its linear portion fixed along the upper edge portion of the recessed portion 2003, and has its circumferential portion fixed to reach the upper edge portion at the opposite side via the bottom portion from the above described upper edge portion. Thereby, when the abutting portion 2009 of the liquid holding member 2001 abuts on the applying roller 1001, abutment along the peripheral surface shape of the applying roller is enabled, and abutment with uniform pressure can be realized.

As described above, in the liquid holding member in this embodiment, the abutting member 2009 formed into one piece without a seam abuts on the outer peripheral surface of the applying roller 1001 in a continuous state without a gap by the urging force of the spring member 2006. As a result, the liquid holding space S becomes a space practically closed by the abutting member 2009, one surface of the space forming base member and the outer peripheral surface of the applying roller 1001, and a liquid is held in the space. In the state in which the rotation of the applying roller 1001 stops, the abutting member 2009 and the outer peripheral surface of the applying roller 1001 keep a liquid-tight state, and the liquid can be reliably prevented from leaking outside. Meanwhile, when the applying roller 1001 rotates, the liquid can pass a space between the outer peripheral surface of the applying roller 1001 and the abutting member 2009 in such a manner as to slip through the space, which will be described later. Here, in the stopping state of the applying roller 1001, the outer peripheral surface of it and the abutting member 2009 being in a liquid-tight state means that a liquid is not passed between the inside and the outside of the above described space. In this case, the abutting state of the abutting member 2009 includes the state in which the abutting member 2009 abuts on the above described outer peripheral surface through a liquid film formed by a capillary force, in addition to the state in which the abutting member 2009 directly contacts the outer peripheral surface of the applying roller 1001.

Meanwhile, as shown in FIG. 16, the space forming base member 2002 is provided with a liquid supply port 2004 and a liquid returning port 2005, which are respectively constructed to include holes penetrating through the space forming base member 2002, in the region surrounded by the abutting member 2009. These ports communicate with cylindrical connecting portions provided in a protruding form on the rear surface side of the space forming base member. Further, the connecting portions are connected to the liquid supply flow path which will be described later. In this embodiment, the liquid supply port 2004 is formed in the vicinity of one end portion (left end portion in FIG. 16) of the region surrounded by the abutting member 2009, and the liquid returning port 2005 is provided in the vicinity of the other end portion (right end portion in FIG. 16) of the same region. The liquid supply port 2009 is configured to supply the liquid supplied from the liquid flow path to the aforementioned liquid holding space S, and the liquid returning port 2005 is configured to discharge the liquid in the liquid holding space S to the liquid flow path. By performing supply and discharge of the liquid, the liquid flows to the right end portion from the above described left end portion in the liquid holding space S.

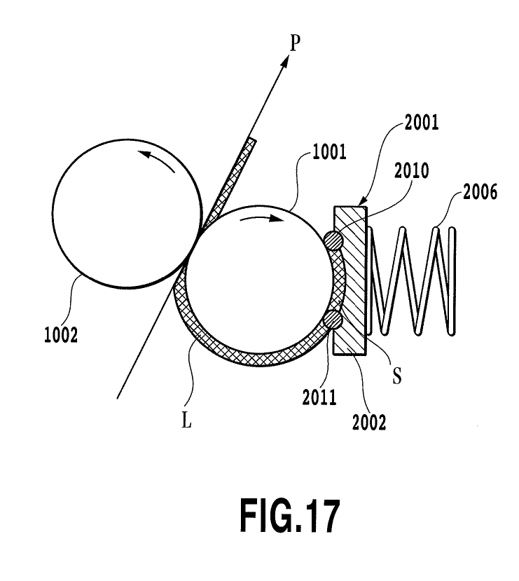

In the above liquid applying apparatus, a applying medium is transferred to between the applying roller 1001 and the counter roller 1002 by the applying medium feeding mechanism 1006, and the applying medium is inserted in between the rollers. With this, the applying medium is transferred to the paper discharge section with the rotation of the applying roller 1001 and the counter roller 1002. During the transfer, the liquid applied on the peripheral surface of the applying roller is transferred onto the applying medium P from the applying roller 1001 as shown in FIG. 17. It goes without saying that the means for supplying the applying medium to between the applying roller 1001 and the counter roller 1002 is not limited to the above described feeding mechanism. For example, means by manual feeding which secondarily uses a predetermined guide member may be used in combination, and any means such as the construction singularly using manual feeding means may be used.

In FIG. 17, the portion expressed by the diagonal lines crossing one another shows the liquid L. Here, the thickness of the liquid layer in the applying roller 1001 and the applying medium P is expressed significantly larger than the actual thickness for the purpose of clearly illustrating the state of the liquid L at the time of applying. As described above, the coated portion of the applying medium P is transferred in the arrow direction by the transfer force of the applying roller 1001. With this, the uncoated portion of the applying medium P is transferred to the contact portions of the applying medium P and the applying roller 1001, and by performing this operation continuously or intermittently, the liquid is applied onto the entire applying medium.

### Other Embodiments

In each of the abovementioned embodiments, the liquid applying apparatus having the liquid applying mechanism is described, and as one mode of such a liquid applying apparatus, an inkjet print apparatus is preferable. Hereinafter, an inkjet print apparatus including the above described liquid applying mechanism will be described.

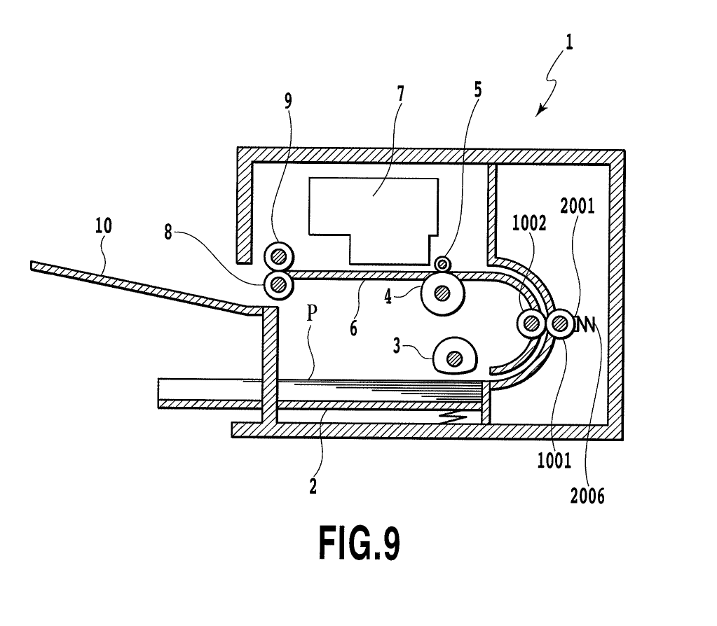

FIG. 9 is a view showing a schematic construction of an inkjet printing apparatus 1 including an applying mechanism having a substantially similar construction to the liquid applying apparatus of the abovementioned embodiments.

The inkjet print apparatus 1 is provided with a paper feed tray 2 loaded with a plurality of print media P, and a semicircular separating roller 3 separates the print media P loaded on the paper feed tray one by one to feed the media P to a conveying passage. In the conveying passage, the applying roller 1001 and the counter roller 1002 which constitute the liquid applying means of the above described liquid applying mechanism are arranged, and the print medium P fed from the paper feed tray 2 is fed to between both the rollers 1001 and 1002. The applying roller 1001 rotates in the clockwise direction in FIG. 18 by rotation of the roller drive motor, and applies the liquid onto the print surface of the print medium P while conveying the print medium P. The print medium P coated with the liquid is fed to between a conveying roller 4 and a pinch roller 5, and the conveying roller 4 rotates in the counterclockwise direction in the drawing, whereby the print medium P is conveyed on a platen 6, and moves to the position opposed to a print head 7 which constitutes printing means. The print head 7 is an inkjet print head in which a predetermined number of nozzles for ejecting an ink are placed, and while the print head 7 scans in the direction perpendicular to the paper surface of the drawing, the print head 7 discharges the ink to the print surface of the print medium P from the nozzles in accordance with the recorded data and performs a print. By alternately repeating the print operation and the conveying operation of a predetermined amount by the conveying roller 4, an image is formed on the print medium. With the image forming operation, the print medium P is nipped by a paper discharge roller 8 and a paper discharge spur 9 which are provided at the rear stream side of the scanning region of the print head in the conveying path of the print medium, and the print medium P is discharged on a paper discharge tray 10 by rotation of the paper discharge roller 8.

As the inkjet print device, a so-called full line type inkjet print apparatus which performs a print operation by using a long print head in which nozzles for ejecting an ink are arranged along the maximum width of a print medium can be constructed.

Further, the liquid used in the present embodiment is a processing liquid which reacts to ink.

Here, as the processing liquid, there is cited a liquid containing a component which causes a coloring material (dye and pigment) in ink to coagulate, for example. As the component causing the coloring material in the ink to cohere, polyvalent metal salt for causing the pigment in the ink to cohere is cited. Polyvalent metal salt is constructed of polyvalent metal salt ions with two valences or more, and anions which are bound with these polyvalent metal ions. Concrete examples of the polyvalent metal ion include bivalent metal ions such as Ca2+, Cu2+, Ni2+, Mg2+ and Zn2+, trivalent metal ions such as Fe3+ and Al3+, and the like. Further, the anions which are bound with these ions include C1−, NO3−, SO4−, I−, Br−, ClO3−, RCOO− (R is an alkyl group) and the like. Further, polyallylamine and the like which cause a dye in ink to cohere is cited.

In the present embodiment, by using the processing liquid as described above as a liquid, the processing liquid and the pigment which is a coloring material of the ink ejected to the print medium coated with the processing liquid react with each other, and cohesion of the pigment is promoted. By promoting cohesion of the pigment, print density can be enhanced. Further, reduction or prevention of bleeding is enabled. It is a matter of course that the liquid which is used in the inkjet print apparatus is not limited to the above described examples.

Further, when the present invention is applied to detection of the liquid amount in a predetermined liquid (ink) holding section in a liquid circulation supply system in a circulation path relating to supply of the ink, and a cleaning mechanism in an inkjet print apparatus, similar effects also can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-323734, filed Dec. 19, 2008, which is hereby incorporated by reference herein in its entirety.

What is claimed is:

1. A liquid applying apparatus comprising:
an applying roller configured to apply a liquid to a medium;
a liquid holding portion configured to contact with said applying roller for holding the liquid to be applied by said applying roller;
a tank configured to store the liquid;
a path configured to make a communication between said liquid holding portion and said storage unit;
a pump configured to cause a flow of the liquid in a flow passage including said liquid holding portion, said storage unit and said path;
a pair of electrodes provided in at least one of said liquid holding portion and said path;
an output unit configured to output information corresponding to a conduction state between said pair of electrodes;
a memory configured to store the information outputted by said output unit at time of a filling operation which uses said pump to fill said liquid holding portion with the liquid supplied from said storage unit through said path;
a setting unit configured to set a threshold value used for determining a completion of a returning operation, which uses said pump to return the liquid in said liquid holding portion to said storage unit through said path, based on the information stored in said memory; and
a determining unit configured to determine whether or not the returning operation is completed, based on the threshold value set by said setting unit and the information outputted by said output unit at time of the returning operation.

2. The liquid applying apparatus as claimed in claim 1, further comprising a print head for ejecting ink to the medium to which the liquid is applied by said applying roller.

3. The liquid applying apparatus as claimed in claim 2, wherein the liquid contains a component which causes a coloring material in the ink to coagulate.
